(19) United States
(12) Patent Application Publication
(10) Pub. No.: US 2011/0271568 A1
(43) Pub. Date: Nov. 10, 2011

(54) Memorabilia display and methods of use

(76) Inventor: Fernando Vitale, Melbourne (AU)

(21) Appl. No.: 13/065,229

(22) Filed: Mar. 16, 2011

Related U.S. Application Data
(60) Provisional application No. 61/314,312, filed on Mar. 16, 2010.

(51) Int. Cl. G09F 19/02; H04N 5/44; H04N 5/66

(52) U.S. Cl. 40/455; 40/446; 40/470; 348/739; 348/734; 348/E05.133; 348/E05.096

(57) ABSTRACT

The invention relates to memorabilia and apparatus for displaying an event or occasion having an audio and/or visual display that is hidden from a viewer. The memorabilia and devices are of particular interest to and use by the sports and/or popular music fanatic. The invention also is drawn to a method for presenting or displaying a sports or a pop item or image thereby providing entertainment to an individual.

### RELATIONSHIP TO OTHER APPLICATIONS

This application is related to and claims priority from U.S. Provisional Patent Application No. 61/314,312, filed 16 Mar. 2010, and which is herein incorporated by reference in its entirety.

### FIELD OF THE INVENTION

The disclosed invention relates to the field of memorabilia for sports and other famous events. More particularly, it relates to a method and apparatus for displaying a piece of sports or event memorabilia with a hidden video display which may be revealed by employing a remote control device or other wireless means. The display appears like a conventional memorabilia display to a viewer until a sliding door disguised as a plaque bearing indicia concerning the memorabilia is activated by remote control or the like to slide and thereby reveal the video display which provides an audio/visual showing concerning the memorabilia.

### BACKGROUND OF THE INVENTION

Memorabilia for sports and other events attended by fans are a popular item for collectors to display. Items relating to sports such as jerseys, hats, baseballs, and the like are collected as hobbies and by investors. The same is true for memorabilia for other events such as rock group performer and other popular music performer concerts, football games, soccer or rugby matches, tennis matches, the Olympic Games, the Tour de France, a religious event, a religious souvenir, a political event, or the like, and a near infinite number of different types of events of interest to people playing or attending them. Concert events may have memorabilia such as T-shirts or photographs, whereas dancing contests might have banners or other memorabilia.

Collectors of such memorabilia, for instance sports memorabilia, conventionally are proud of their ownership of a piece of sports history, and generally wish to display it in their home or office. Such displays conventionally take the form of a frame with a glass or clear plastic front wall which allows viewing of the underlying memorabilia, but also protects it from harm of constant touching by admirers or from air pollution and the like.

For fans knowing about the player or team or group, the displayed memorabilia represents, viewing the displayed jersey or hat or other item, instantly brings to mind the team or player or event to which the item displayed relates. However even fans of the sport or player relating to the memorabilia may not know the exact story relating to it, or an exiting instance which occurred which might be related to the displayed item. For non-fans, viewing the displayed item may simply perplex them since they have no knowledge to draw upon and relate.

Many display cases and frames will include a plaque or card adjacent to the memorabilia, which will bear indicia describing the displayed item, or perhaps the event to which the item relates. However, writing indicia or a small picture on a card or plaque, cannot tell the full story of an exciting event or instance which may not be known to the viewer, especially if they are not fans of the sport or event concerned.

On some occasions, for fans of the sport, player, or event to which the item displayed relates, it might be the owner's inclination to provide the very limited information that a card or plaque bears on purpose. For instance in dealing with sports, frequently fans will argue good-naturedly over the event, an occurrence, or a player, in a contest as to who knows the most about it. In such cases, the bare minimum of information displayed on a plaque or card may be all the owner wishes to initially reveal.

However, when dealing with non fans or viewers unfamiliar with the displayed item, or with rabid fans who purport to know more about the item than the owner, it would be preferable to allow the owner to immediately provide the viewer with more information about the item and how it relates to a player or team or event.

Still further, such a system, while providing the viewer with more information, if internet enabled, say as by wireless router, could also provide current internet information on the displayed item, similar items, or the current value of such items. The software running on the device to display the video when activated, can also be adapted to search out the appropriate related information from related sites.

As such, there exists an unmet need, for a device and method which will allow for the display of memorabilia from sports, or players, or groups, or events, or other items of interest to fans, in a manner to provide sufficient indicia, adjacent to the item to identify it or the event. Such a device should also provide the owner with the option of revealing much more information to a viewer, if the owner so chooses, but to hide such information until the owner decides it is prudent to provide it. Finally, such a device or apparatus should allow the owner to activate a means to provide more information, for example remotely, when the owner decides it is prudent and thereby provide a surprise factor to get the viewer's attention.

These such devices or apparatus together with other objects and advantages which will become subsequently apparent reside in the details of the system and apparatus display of memorabilia herein and as more fully hereinafter described and claimed, reference being had to the accompanying drawings forming a part thereof.

### SUMMARY OF THE INVENTION

It is thus an object of the invention to provide a memorabilia display which functions in a conventional manner to display memorabilia adjacent or proximal to a plaque or card bearing indicia about the displayed item.

In one embodiment, the invention provides such a device or apparatus which will also provide the user or viewer with extra information about the displayed item by further providing an audio/visual display of information concerning the displayed item.

In another embodiment, the invention provides the audio/visual display of additional information by a remote control device and only when the user or owner wishes to allow a viewer to see the extra information.

In yet another embodiment, the invention provides adaptable display software that also provides information related to the item, or to its value, or related items, via the internet.

One embodiment of the system herein described, features a memorabilia display such as conventional displays which have a frame or housing providing a viewable mounting of a displayed item on a frontal surface. In one embodiment, glass or other transparent or translucent material, such as plastics, PLEXIGLAS, PERSPEX, LUCITE, or the like, may cover the displayed item. In an alternative embodiment, there is no cover material. In another embodiment, the display device can be in a static or default position and may simply display an item for a viewer adjacent to a card or plaque bearing information about the displayed item.

The memorabilia display may feature a hidden audio/visual display which may be revealed by the user of owner employing a remote control device, to thereby communicate a wireless signal to the device. The wireless signal may be received by an onboard receiver in the device and can activate the card or plaque bearing the indicia to translate or transpose thereby revealing an underlying video display or the like. The device can comprise an onboard microprocessor or other similar hardware and audio components and visual components thus providing video images and providing audio for presentation to a viewer covering the displayed item as log as the covering card or plaque is translated or transposed out of the way.

Upon finishing the presentation provided by the video display and audio, the card or plaque can be translated or transposed to cover and hide or conceal the video display from a viewer until the remote control device is again activated.

Viewers may thus be provided additional visual and/or audio information about the displayed item, at the option of the user or owner and their decision to use the remote to transmit the wireless signal to translate the card or plaque and activate the audio/visual display.

The invention provides a memorabilia display device comprising a display housing, the display housing comprising a frame, a rigid support, a planar indicia display, the rigid support further comprising a recess, the recess defining a cavity and an opening, wherein the planar indicia display is shaped and adapted for positioning and placement within the recess cavity, wherein the recess further comprises means for supporting and retaining the planar indicia, and wherein the recess further comprises means for transposing the planar indicia within the recess cavity. In one preferred embodiment, the means for transposing the planar indicia comprises a device selected from the group consisting of a motor, a pair of wheels, a track, a rail, a spring, a piston, an actuator, and an elastic element. In a more preferred embodiment, the motor is selected from the group consisting of a servo motor, a rotary hydraulic motor, a linear hydraulic motor, a pneumatic motor, and an electric motor. In another more preferred embodiment, the spring is selected from the group consisting of a tunable spring, a clockwork spring, and a damper. In a preferred embodiment, the rigid support comprises a material selected from the group consisting of steel, copper, aluminum, metal matrix composite, metal alloy, acrylonitrile butadiene styrene (ABS), nylon, polypropylene, polybromate, polycarbonate, glycolised polyethylene terephthalate (PETg) copolyester, olytetrafluorethylene (PTFE), ePTFE, polypropylene, a polymer, glass fiber-resin composites, carbon fiber resin composites, wood, paper, and card. In a yet other preferred embodiment, the display housing further comprises a cover. In a more preferred embodiment, the cover comprises a transparent or translucent material, wherein the transparent or translucent material is selected from the group consisting of glass, acrylic plastic, PLEXIGLAS, PERSPEX, and LUCITE. In a more preferred embodiment, the recess cavity comprises a video display. In another more preferred embodiment, the recess cavity further comprises an audio device.

In another preferred embodiment, the memorabilia display device further comprises a memorabilia display item, wherein the memorabilia display item is placed adjacent to the planar indicia display. In a more preferred embodiment, the memorabilia display item is selected from the group consisting of a sports item, a rock music item, a pop music item, a classical music item, a religious item, a politically related item, or the like.

In another preferred embodiment, the memorabilia display device as described herein further comprises a microprocessor, wherein the microprocessor is in electronic communication with the means for transposing the planar indicia. In a more preferred embodiment, the memorabilia display device further comprises a radio receiver, wherein the radio receiver is in electronic communication with the microprocessor. In an alternative more preferred embodiment, the memorabilia display device further comprising a radio receiver, wherein the radio receiver is in electronic communication with the means for transposing the planar indicia.

In another preferred embodiment the memorabilia display device as described herein further comprises a power source, wherein the power source is in electronic communication with the means for transposing the planar indicia. In a more preferred embodiment, the power source is selected from the group consisting of a battery, a photovoltaic cell, a fuel cell, a hydrogen generator, and a generator. In a most preferred embodiment the memorabilia display device further comprises a power supply circuit, wherein the power supply circuit is in electronic communication with the means for transposing the planar indicia and the power source.

In one other preferred embodiment the memorabilia display device as described herein further comprises a separate remote control device.

In another embodiment, the invention proves a method for revealing an audio/visual device hidden in a memorabilia display device, the method comprising the steps of (i) providing the memorabilia display device as described herein, the memorabilia display device in its static or default position having the card or plaque covering the audio/visual device (ii) viewing the memorabilia display device, (iii) activating the remote control device, wherein activating translates the card or plaque, (iv) revealing the audio/visual device, and (v) activating the audio/visual device.

### BRIEF DESCRIPTION OF THE DRAWINGS

FIG. 1 depicts the disclosed memorabilia display in its static or default position having the display with a card or plaque bearing indicia adjacent to the item displayed.

FIG. 2 depicts the display transitioning from the static position, to reveal the hidden audio visual display.

FIG. 3 depicts the display herein described with the hidden display fully revealed.

### DETAILED DESCRIPTIONS OF THE PREFERRED EMBODIMENT

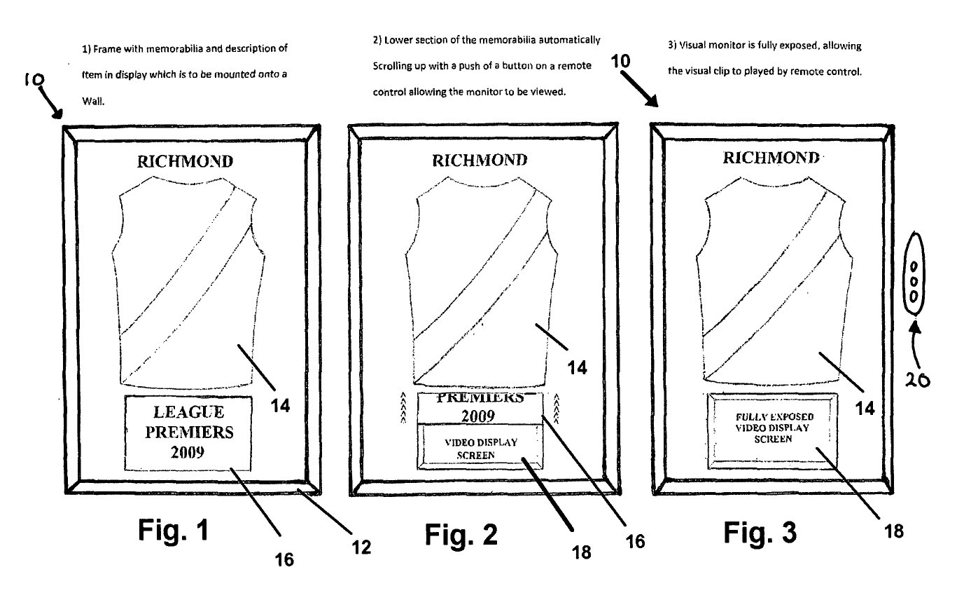

Referring now to the drawings, FIG. 1-3 depict the disclosed memorabilia display device 10 and its various positions during use.

In FIG. 1, the device 10, is shown with the display 12 housing a displayed item 14, and having a planar indicia display 16 adjacent to the displayed item 14. In FIG. 1, the display housing 12 is shown in its static or default position wherein the planar indicia display 16 is fixed in position and bears indicia adjacent to the item 14 displayed.

In use, should the owner or user wish, they may activate a remote control 20 to render a wireless signal that is received by electronic components of the device 10 adapted to do so. Upon receipt of the signal, mechanical means is activated to translate the planar indicia display 16 out of the way of an underlying video display 18.

As shown in FIG. 3, the device 10 has the planar indicia display 16 translated totally out of the way of the underlying video display 18. The viewer may now view a video on the video display 18 concerning the displayed item 14 and hear audio about it.

Once the audio visual display has concluded, the planar indicia display 16 translates back to the static position of FIG. 1. The provision of the remote control, and the remotely activated sliding of the planar indicia display 16 to reveal and activate the onboard audio visual show for the viewer, allows the owner or user to decide if and when they wish to allow the viewer to see the hidden showing provided.

Alternatively as noted above, the device 10 may be connected to the internet or another wide area network using an onboard microprocessor, software adapted to the task, and a conventional WiFi transceiver. Such components are well known in the art and need not be overly described. In this mode of the device 10 the video display 18 could also display video from the internet on the subject matter relating to the displayed item 14.

Further, in another mode of operation, the device 10 might be placed at a sports venue, stadium, sports bar, or the like, and provide users with a means to activate the planar indicia display 16 to translate and reveal the underlying video display 18 and listen and view the information provided thereby. A coin or bill accepting device may be linked directly or wirelessly to the device 10 and activate the translating function of translating the planar indicia display 16 to reveal the video display 18 where the buyer could view and listen to the provided information. Or a cellphone and bluetooth linking means could be provided to allow the user to pay using their phone.

In this pay to view mode, the provided information would be about, or relate to, the displayed item 14, which was of interest to the person paying to get more information. In this mode, the planar indicia display 16 would act not only as a means to provide information about the displayed item 14, it could be made from metal or hardened plastic as a means to protect the underlaying video display 18 from damage. In this mode of the device 10, revenue can thus be generated from fan or user interest in the displayed item 14 at a venue where such interest would frequently be located.

While all of the fundamental characteristics and features of the improved disclosed method and apparatus for displaying memorabilia with reference to particular embodiments thereof have been shown and described, a latitude of modification, various changes and substitutions are intended in the foregoing disclosure and it will be apparent that in some instance, some features of the invention will be employed without a corresponding use of other features, or steps may be rearranged for operations, without departing from the scope of the invention as set forth. It should be understood that such substitutions, modifications, and variations may be made by those skilled in the art without departing from the spirit or scope of the invention. Consequently, all such modifications and variations are included within the scope of the invention as defined herein.

I claim:

1. A memorabilia display device comprising a display housing, the display housing comprising a frame, a rigid support, a planar indicia display, the rigid support further comprising a recess, the recess defining a cavity and an opening, wherein the planar indicia display is shaped and adapted for positioning and placement within the recess cavity, wherein the recess further comprises means for supporting and retaining the planar indicia, and wherein the recess further comprises means for transposing the planar indicia within the recess cavity.

2. The memorabilia display device of claim 1 wherein the means for transposing the planar indicia comprises a device selected from the group consisting of a motor, a pair of wheels, a track, a rail, a spring, a piston, an actuator, and an elastic element.

3. The memorabilia display device of claim 2 wherein the motor is selected from the group consisting of a servo motor, a rotary hydraulic motor, a linear hydraulic motor, a pneumatic motor, and an electric motor.

4. The memorabilia display device of claim 2 wherein the spring is selected from the group consisting of a tunable spring, a clockwork spring, and a damper.

5. The memorabilia display device of claim 1 further comprising a microprocessor, wherein the microprocessor is in electronic communication with the means for transposing the planar indicia.

6. The memorabilia display device of claim 1 further comprising a radio receiver, wherein the radio receiver is in electronic communication with the microprocessor.

7. The memorabilia display device of claim 1 further comprising a radio receiver, wherein the radio receiver is in electronic communication with the means for transposing the planar indicia.

8. The memorabilia display device of claim 1 further comprising a power source, wherein the power source is in electronic communication with the means for transposing the planar indicia.

9. The memorabilia display device of claim 8, wherein the power source is selected from the group consisting of a battery, a photovoltaic cell, a fuel cell, a hydrogen generator, and a generator.

10. The memorabilia display device of claim 8 further comprising a power supply circuit, wherein the power supply circuit is in electronic communication with the means for transposing the planar indicia and the power source.

11. The memorabilia display device of claim 1 wherein the display housing further comprises a cover.

12. The memorabilia display device of claim 11, wherein the cover comprises a transparent or translucent material, wherein the transparent or translucent material is selected from the group consisting of glass, acrylic plastic, PLEXIGLAS, PERSPEX, and LUCITE.

13. The memorabilia display device of claim 1, wherein the device further comprises a memorabilia display item.

14. The memorabilia display device of claim 13, wherein the memorabilia display item is selected from the group consisting of a sports item, a rock music item, a pop music item, and a classical music item.

15. The memorabilia display device of claim 14, wherein the memorabilia display item is a sports item.

16. The memorabilia display device of claim 1, wherein the recess cavity comprises a video display.

17. The memorabilia of claim 1, wherein the recess cavity further comprises an audio device.

18. The memorabilia display device of claim 1, wherein the memorabilia display device further comprises a separate remote control device.

19. The memorabilia display device of claim 1, wherein the planar indicia in placement within the recess cavity and covering the opening is in a static or default position.

20. A method for revealing an audio/visual device hidden in a memorabilia display device, the method comprising the steps of (i) providing the memorabilia display device of claim 1, the memorabilia display device in its static or default position having the card or plaque covering the audio/visual device (ii) viewing the memorabilia display device, (iii) activating the remote control device, wherein activating translates the card or plaque, (iv) revealing the audio/visual device through the opening in the recess, and (v) activating the audio/visual device.
